(19) United States
(12) Patent Application Publication
(10) Pub. No.: US 2008/0306797 A1
(43) Pub. Date: Dec. 11, 2008

(54) METHOD AND SYSTEM FOR AUTOMATED RESOURCE MANAGEMENT AND OPTIMIZATION

(75) Inventors: Mohammed F. Fayaz, Pleasantville, NY (US); Bradley P. Jones, Pleasant Valley, NY (US); Debra C. Leach, Salt Point, NY (US); Richard P. Volant, New Fairfield, CT (US)

Correspondence Address: CANTOR COLBURN LLP - IBM FISHKILL, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/761,081

(22) Filed: Jun. 11, 2007

(51) Int. Cl. G05B 19/00

(52) U.S. Cl. 705/8

(57) ABSTRACT

A method for automated resource management and optimization, the method includes: monitoring one or more of the following: resource usage, level of resource utilization, and resource amenities; receiving a request for reserving a resource; determining whether the request for the resource is granted as originally requested; wherein the determining of whether to grant the request for resources as originally requested is based one or more thresholds and conditions; wherein the one or more thresholds and conditions are based on the monitoring of at least one of the following: resource usage, the level of resource utilization; and resource amenities; and wherein if the request for reserving a resource fails to meet the one or more thresholds and conditions the request is either denied or modified.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to computer software, and more particularly to a method and system for automated resource management and optimization.

2. Description of the Related Art

The conservation and efficient use of resources is always an important consideration for an organization. In an organization, resources, such as a conference rooms, are reserved on a repeated basis. In some instances, the number of individuals utilizing a conference room may be significantly less than the capacity of the reserved conference room, while another group may actually require the larger capacity conference. In other instances, the amenities of the conference room may not match the requirements of the reserving group. Conference room amenities may include communication, teleconferencing, networking equipment and their associated connections, as well as multimedia equipment, presentation and recording equipment, and computer and various other types of office and information processing equipment. Finally, conference rooms may be reserved on a repeated scheduled basis, and subsequently not used. The inefficient use of conference room space leads to increased overhead for an organization including increased utility and rental costs. Therefore there is a need to better manage and utilize resources, such as conference room space, by an organization.

### SUMMARY OF THE INVENTION

Embodiments of the present invention include a method and system for automated resource management and optimization, wherein the method includes: monitoring one or more of the following: resource usage, level of resource utilization, and resource amenities; receiving a request for reserving a resource; determining whether the request for the resource is granted as originally requested; wherein the determining of whether to grant the request for resources as originally requested is based one or more thresholds and conditions; wherein the one or more thresholds and conditions are based on the monitoring of at least one of the following: resource usage, the level of resource utilization; and resource amenities; and wherein if the request for reserving a resource fails to meet the one or more thresholds and conditions the request is either denied or modified.

A system for automated resource management and optimization, the system includes: one or more server devices in communication with one or more client devices through a network; the server devices and the client devices configured to execute electronic software that manages the resource management and optimization; wherein the electronic software is resident on storage mediums in signal communication with the client and server devices; wherein the electronic software comprises a series of algorithms for: monitoring one or more of the following: resource usage, level of resource utilization, and resource amenities; receiving a request for reserving a resource; determining whether the request for the resource is granted as originally requested; wherein the determining of whether to grant the request for resources as originally requested is based one or more thresholds and conditions; wherein the one or more thresholds and conditions are based on the monitoring of at least one of the following: resource usage, the level of resource utilization; and resource amenities; and wherein if the request for reserving a resource fails to meet the one or more thresholds and conditions the request is either denied or modified.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, a solution is technically achieved for a method and system for automated resource management and optimization. A software algorithm monitors resource usage and the level of resource utilization, and is configured to perform dynamic scheduling and to provide optimization of the resource.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a flow diagram the main program of a software algorithm that monitors resource usage and the level of resource utilization, and is configured to perform dynamic scheduling and to provide optimization of the resource according to an embodiment of the invention.

FIG. 2 illustrates a flow chart of a frequency of usage assessment module algorithm according to an embodiment of the invention.

FIG. 3 illustrates a flow chart of a quality of usage module algorithm according to an embodiment of the invention.

FIG. 4 illustrates a system for implementing embodiments of the invention.

The detailed description explains the preferred embodiments of the invention, together with advantages and features, by way of example with reference to the drawings.

### DETAILED DESCRIPTION

Embodiments of the invention provide a method and system for automated resource management and optimization. A software algorithm monitors resource usage and the level of resource utilization, and is configured to perform dynamic scheduling and to provide optimization of the resource.

In an embodiment of the invention, a software algorithm is configured to monitor usage and the level of utilization of conference rooms. The software algorithm has the ability to cancel room reservations of parties that consistently do not use the conference room, thereby freeing up the room for another group to use. The algorithm also takes into account the size of the group reserving a room, so as to save larger rooms for larger groups that require them. The algorithm tracks the amenities of the conference rooms, and matches the requirements of the reserving group with an appropriately equipped room. Conference room amenities may include communication, teleconferencing, networking equipment and their associated connections, as well as multimedia equipment, presentation and recording equipment, and computer and various other types of office and information processing equipment. Embodiments of the software algorithm of the invention may also collect data so as to determine what further equipment and other resources may be needed for future use.

In embodiments of the invention, software algorithms utilize a frequency of usage evaluation module and a quality of usage evaluation module. The frequency of usage evaluation module evaluates the requested reservation of resources against the actual historical usage of the requested resource. If usage of the resource by the requestor is below a predetermined level, a warning is sent to the reserving user. If the resource usage is also below the cancellation limit, then the reservation is cancelled, and the resource is released and made available to others for the time period of the cancelled reservation. The quality of usage evaluation module determines if the number of elements requiring a requested resource can be optimized. For example, if only ten people repeatedly use a conference room that can seat twenty people, then a smaller room may be located and used if available. Additional filters configured for the optimization of resource usage may comprise the length of the event that the reservation of the resource is for, and the type of amenities and facilities infrastructure that are required by the reserving entity. In embodiments of the invention, filters can be weighted to optimize customer satisfaction, as well as to accommodate requesting users by rank. In addition, filters can be utilized to generate reports on how to improve available resources and or facilities. For example, a determination can be made on where and what types of audio-visual equipment is required.

Algorithms of the present invention can be applied to resources such as conference rooms, hospital rooms, ticket sales, boat slips, nursing home facilities, inventory or floor stock in a retail environment, zoos, kennels, warehouse storage, freight and shipping systems, among others.

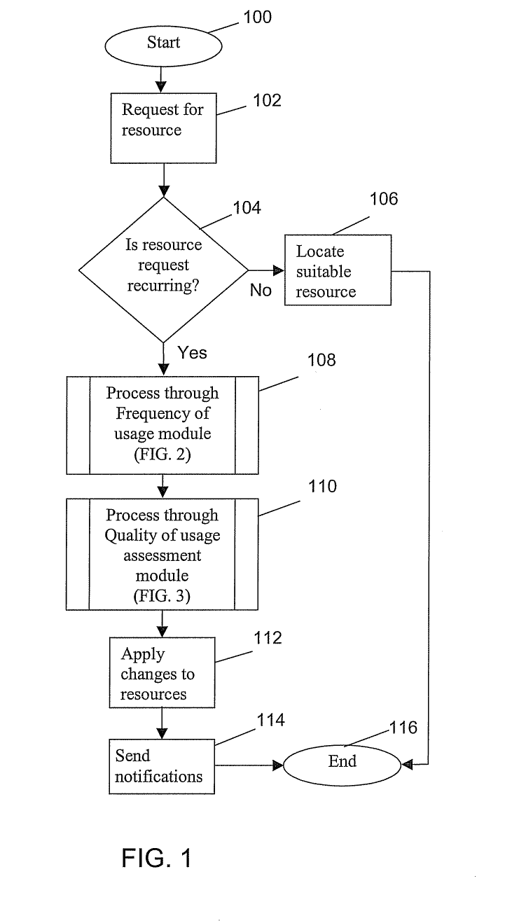

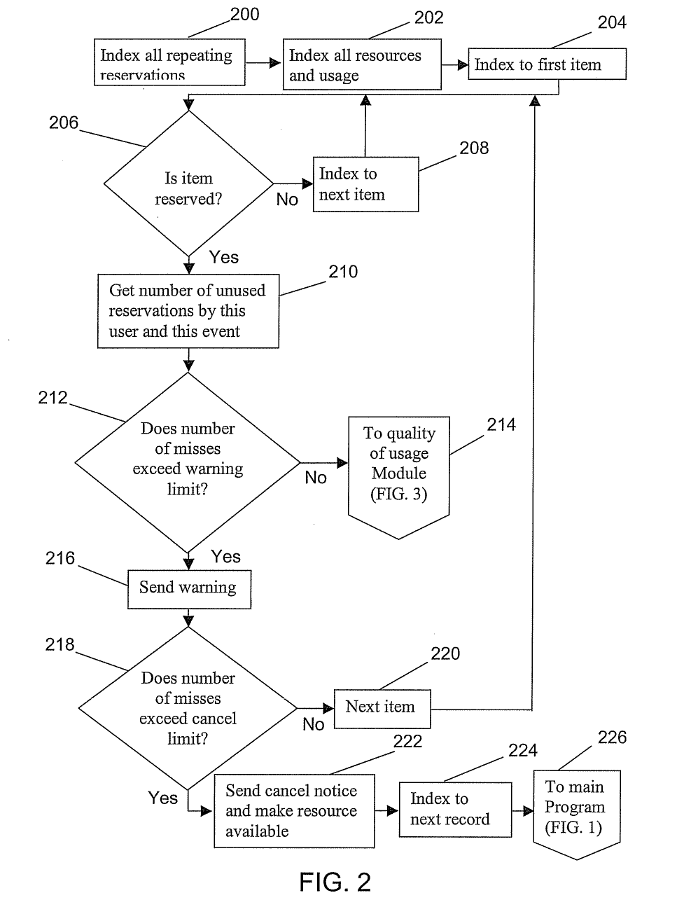

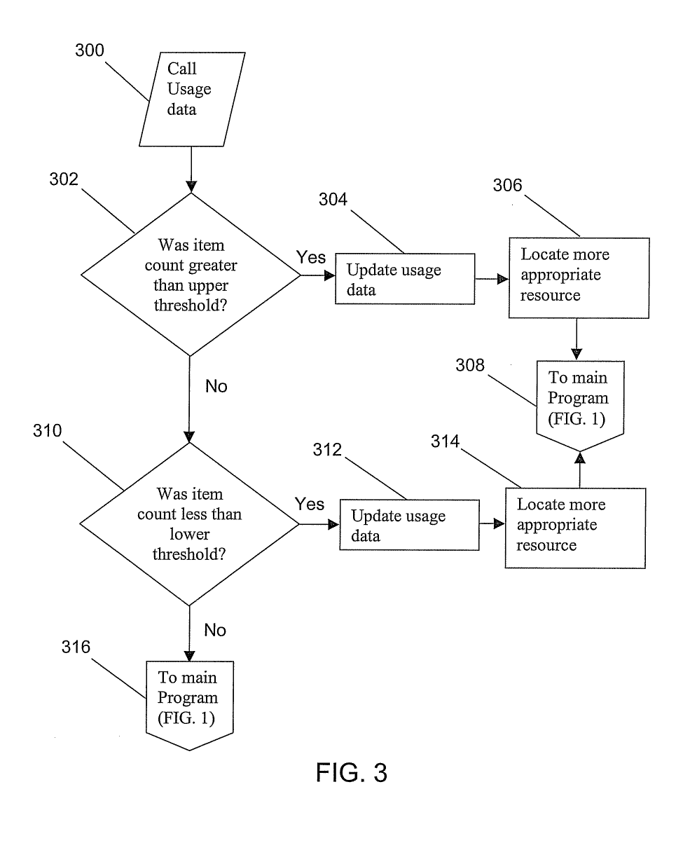

FIGS. 1-3 are flow diagrams of an algorithm that monitors resource usage and the level of resource utilization, and is configured to perform dynamic scheduling and to provide optimization of the resource according to an embodiment of the invention. In FIG. 1, the main algorithm is started (block 100) with a request for a resource (block 102). If the algorithm determines that the resource request is a first request, or has not been a recurring request (block 104 is No), the algorithm locates and assigns a suitable resource to the requestor (block 106) and the algorithm ends (block 116). If the resource request is determined to be a recurring request (block 104 is True), the resource request is processed by a call to the frequency of usage module (block 108 and FIG. 2). Subsequently, the resource request is processed by a call to the quality of usage assessment module (block 110 and FIG. 3). Based on the determinations of the frequency of usage module (block 108 and FIG. 2) and quality of usage assessment module (block 110 and FIG. 3), changes are made to the resources (block 112), and notifications are sent (block 114) by the algorithm to the requester with regards to the status of their request, and to other concerned parties. The algorithm then terminates (block 116).

FIG. 2 illustrates a flow chart of a frequency of usage assessment module algorithm according to an embodiment of the invention. Within the usage assessment module algorithm indexes of all repeating resource reservations (block 200) and all resource usages are maintained (block 202). Upon a request from the main algorithm (FIG. 1), the frequency of usage assessment module indexes to the first item (block 204) of conference room information. The algorithm determines if the first item in the first record is subject to the reservation (block 206). If the item is not reserved (block 206 is No), the algorithm continues to index to the next item of the record until an item that is reserved is found (Block 206 is Yes). When an item that is reserved is found (block 206 is Yes), the number of unused past reservations by the reserving party and this event is determined (block 210). If the number of missed reservations by the reserving party does not exceed a predefined warning limit (block 212 is No), the frequency of usage assessment module algorithm calls the quality of usage module (214 and FIG. 3). If the number of missed reservations by the reserving party does exceed a predefined waning limit (block 212 is Yes), a warning is sent (block 216) to the reserving party. If the algorithm determines that the number of missed reservations does not exceed a predefined cancellation limit (block 218 is No), the reservation is executed, and the next item (block 220) of the requester is considered. If however, the number of missed reservations does exceed a predefined cancellation limit (block 218 is Yes), a cancellation notice is sent to the requestor and other concerned parties, and the resource is freed up and made available for the time of the original requested reservation. Subsequently, the record is index to the next record (block 224), and the frequency of usage assessment module algorithm returns to the main portion of the algorithm (block 226).

FIG. 3 illustrates a flow chart of a quality of usage module algorithm according to an embodiment of the invention. The quality of usage module algorithm starts with obtaining capacity and usage information for the requestor of the resource with a call to the usage data (block 300). If an item count is greater then the threshold of a requested resource (block 302 is yes) (for example, twenty people cannot be placed in a room for ten), the usage data is updated (block 304), and a more appropriate resource (block 306) is found for the requester. The program then returns to the main algorithm (block 308) to finish executing the request. If however, an item count is lower then the threshold (block 310 is Yes) (for example, ten people being placed in a room with capacity for twenty people), the usage data is updated (block 312), and a more appropriate resource (block 314) is found for the requester. The program then returns to the main algorithm (block 308) to finish executing the request. If the amount of the requester item is within both the upper (block 302) and lower (block 310) thresholds, the quality of usage module algorithm returns to the main algorithm to complete the requestors reservation request as originally entered

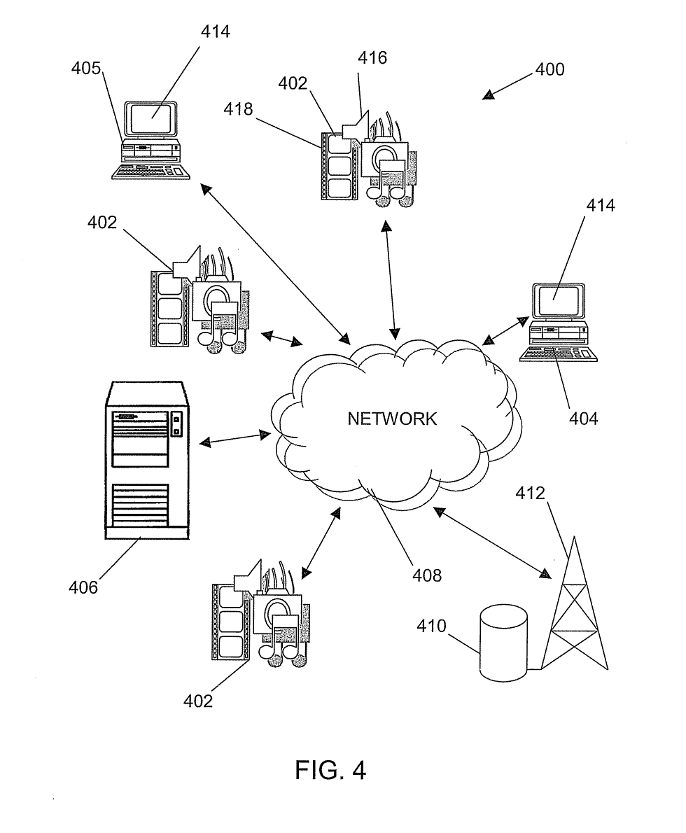

FIG. 4 is a block diagram of an exemplary system 400 for implementing an algorithm that monitors resource usage and the level of resource utilization, and is configured to perform dynamic scheduling and to provide optimization of the resource according to an embodiment of the invention, and graphically illustrates how these blocks interact in operation. The system 400 includes remote devices including one or more multimedia/communication devices 402 equipped with speakers 416 for implementing the audio, as well as display capabilities 418 for facilitating graphical user interface (GUI) aspects of the present invention. In addition, mobile computing devices 204 and desktop computing devices 405 equipped with displays 414 for use with the GUI of the present invention are also illustrated. The remote devices 402 and 404 may be wirelessly connected to a network 408. The network 408 may be any type of known network including a local area network (LAN), wide area network (WAN), global network (e.g., Internet), intranet, etc. with data/Internet capabilities as represented by server 406. Communication aspects of the network are represented by cellular base station 410 and antenna 412. Each remote device 402 and 404 may be implemented using a general-purpose computer executing a computer program for carrying out the GUI described herein. The computer program may be resident on a storage medium local to the remote devices 402 and 404, or maybe stored on the server system 406 or cellular base station 410. The server system 406 may belong to a public service. The remote devices 402 and 404, and desktop device 405 may be coupled to the server system 406 through multiple networks (e.g., intranet and Internet) so that not all remote devices 402, 404, and desktop device 405 are coupled to the server system 406 via the same network. The remote devices 402, 404, desktop device 405, and the server system 406 may be connected to the network 408 in a wireless fashion, and network 408 may be a wireless network. In a preferred embodiment, the network 408 is a LAN and each remote device 402, 404 and desktop device 405 executes a user interface application (e.g., web browser) to contact the server system 406 through the network 408. Alternatively, the remote devices 402 and 404 may be implemented using a device programmed primarily for accessing network 408 such as a remote client.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may male various improvements and enhancements which fall within the scope of the claims which follow. These claims should be construed to maintain the proper protection for the invention first described.

What is claimed is:

1. A method for automated resource management and optimization, wherein the method comprises:
monitoring one or more of the following: resource usage, level of resource utilization, and resource amenities;
receiving a request for reserving a resource;
determining whether the request for the resource is granted as originally requested;
wherein the determining of whether to grant the request for resources as originally requested is based one or more thresholds and conditions;
wherein the one or more thresholds and conditions are based on the monitoring of at least one of the following: resource usage, the level of resource utilization; and resource amenities; and
wherein if the request for reserving a resource fails to meet the one or more thresholds and conditions the request is either denied or modified.

2. The method of claim 1, wherein in the monitoring of resource usage comprises:
determining whether the request for reserving the resource is a recurring event; and
determining if a requester has exceeded a threshold of reserving the resource and failing to use the resource without proper cancellation of the reservation.

3. The method of claim 2, wherein if the requester has exceeded the threshold the requestor is issued a warning, and the resource is reserved.

4. The method of claim 2, wherein if the requestor has exceeded the threshold, the resource reservation request is denied

5. The method of claim 1, wherein the monitoring of the level of resource utilization comprises:
determining the amount of requested resource that is required by a requester; and
matching the amount of the requested resource with a suitable and available resource.

6. The method of claim 1, wherein the monitoring resource amenities comprises:
determining the amenities required by the requester; and
matching the amenities required by the requestor with a suitable and available resource.

7. A method of optimizing allocation of conference room resources for a recurring meeting scheduled for repeated use of one of a plurality of conference rooms, each equipped with associated support equipment, comprising:
determining data relating to actual utilization of the conference room and support equipment of at least one instance of the recurring meeting;
inputting the actual utilization data into a software algorithm on a computing device;
storing on the computing device data relating to capacity of each of the plurality of conference rooms and capabilities of the associated support equipment;
wherein the software algorithm is configured to compare the actual utilization to the capacity and capability information; and
wherein the software algorithm is configured to re-assign the recurring meeting to an alternative conference room having alternative support equipment to more efficiently match resources to actual utilization, provided a more efficient match exists.

8. A system for automated resource management and optimization, the system comprising:
one or more computing devices configured to execute electronic software that manages the resource management and optimization;
wherein the electronic software is resident on storage mediums in signal communication with the computing devices;
wherein the electronic software comprises a series of algorithms configured for:
monitoring one or more of the following: resource usage, level of resource utilization, and resource amenities;
receiving a request for reserving a resource;
determining whether the request for the resource is granted as originally requested;
wherein the determining of whether to grant the request for resources as originally requested is based one or more thresholds and conditions;
wherein the one or more thresholds and conditions are based on the monitoring of at least one of the following: resource usage, the level of resource utilization; and resource amenities; and
wherein if the request for reserving a resource fails to meet the one or more thresholds and conditions the request is either denied or modified.

9. The system of claim 8, wherein in the monitoring of resource usage comprises:
determining whether the request for reserving the resource is a recurring event; and
determining if a requester has exceeded a threshold of reserving the resource and failing to use the resource without proper cancellation of the reservation.

10. The system of claim 9, wherein if the requestor has exceeded the threshold the requester is issued a warning, and the resource is reserved.

11. The system of claim 9, wherein if the requestor has exceeded the threshold, the resource reservation request is denied

12. The system of claim 8, wherein the monitoring of the level of resource utilization comprises:
determining the amount of requested resource that is required by a requester; and
matching the amount of the requested resource with a suitable and available resource.

13. The system of claim 8, wherein the monitoring resource amenities comprises:
determining the amenities required by the requestor; and
matching the amenities required by the requestor with a suitable and available resource.

14. The system of claim 8, where the computing devices comprise a network of client and server devices.
